(19) United States
(12) Patent Application Publication
(10) Pub. No.: US 2019/0339604 A1
(43) Pub. Date: Nov. 7, 2019

(54) OPTICAL UNIT, LIGHT SOURCE APPARATUS, AND PROJECTION TYPE DISPLAY APPARATUS

(71) Applicant: CANON KABUSHIKI KAISHA, Tokyo (JP)

(72) Inventor: Eiji Takeuchi, Kawasaki-shi (JP)

(21) Appl. No.: 16/511,118

(22) Filed: Jul. 15, 2019

Related U.S. Application Data
(63) Continuation of application No. PCT/JP2018/002292, filed on Jan. 25, 2018.

(30) Foreign Application Priority Data
Feb. 17, 2017 (JP) 2017-028519

(51) Int. Cl. G03B 21/20; G02B 27/14; F21V 7/22

(52) U.S. Cl. CPC G03B 21/2033; F21V 7/22; G02B 27/141

(57) ABSTRACT

An optical unit according to one aspect of the present invention includes a substrate, and a fluorescent layer provided on the substrate. The fluorescent layer includes an adhered portion adhered to the substrate and a non-adhered portion that is not adhered to the substrate. The substrate has a concave portion containing an air gap and an adhesive. The adhered portion is part in the fluorescent layer corresponding to a region where the adhesive is provided. An end of the fluorescent layer is located outside the concave portion.

### CROSS-REFERENCE TO RELATED APPLICATIONS

This application is a Continuation of International Patent Application No. PCT/JP2018/002292, filed on Jan. 25, 2018, which claims the benefit of Japanese Patent Application No. 2017-028519, filed on Feb. 17, 2017, both of which are hereby incorporated by reference herein in their entirety.

### BACKGROUND OF THE INVENTION

### Field of the Invention

The present invention relates to an optical unit having a fluorescent or phosphor layer, a light source apparatus, and a projection type display apparatus each having the optical unit.

### Description of the Related Art

A recently developed projector uses, as a light source, fluorescent light with a wavelength that has been converted by irradiating excitation light from a solid light source, such as a laser diode, onto a fluorescent layer. Japanese Patent Application Publication No. (“JP”) 2013-120713 discloses a light emitting plate formed by adhering a fluorescent layer (phosphor containing layer) onto a reflection plate.

However, the light emitting plate disclosed in JP 2013-120713 adhere the fluorescent layer (phosphor containing layer) to the reflection plate over its one entire surface. Since the fluorescent layer and the reflection plate have coefficients of thermal expansion different from each other, the configuration of JP 2013-120713 causes a force to be applied from the reflection plate to the fluorescent layer as the temperature changes, and the fluorescent layer to be degraded.

### SUMMARY OF THE INVENTION

The present invention provide an optical unit, a light source apparatus, and a projection type display apparatus, each of which can suppress a deterioration of a fluorescent layer.

An optical unit according to one aspect of the present invention includes a substrate, and a fluorescent layer provided on the substrate. The fluorescent layer includes an adhered portion adhered to the substrate and a non-adhered portion that is not adhered to the substrate. The substrate has a concave portion containing an air gap and an adhesive. The adhered portion is part in the fluorescent layer corresponding to a region where the adhesive is provided. An end of the fluorescent layer is located outside the concave portion. A light source apparatus and a projection type display unit including the above optical unit also constitute another aspect of the present invention.

Further features of the present invention will become apparent from the following description of exemplary embodiments with reference to the attached drawings.

### BRIEF DESCRIPTION OF THE DRAWINGS

FIGS. 1A and 1B are explanatory views of an optical unit according to a first embodiment.

FIGS. 2A, 2B, and 2C are explanatory views of an optical unit according to a second embodiment.

FIGS. 3A, 3B, and 3C are explanatory views of an optical unit according to a third embodiment.

FIGS. 4A, 4B, and 4C are explanatory views of an optical unit according to a fourth embodiment.

FIGS. 5A, 5B, and 5C are explanatory views of an optical unit according to a fifth embodiment.

FIG. 6 is a structural view of a light source apparatus according to a sixth embodiment.

FIG. 7 is a structural view of a projector according to a seventh embodiment.

### DESCRIPTION OF THE EMBODIMENTS

Referring now to the accompanying drawings, a description will be given of embodiments according to the present invention.

### First Embodiment

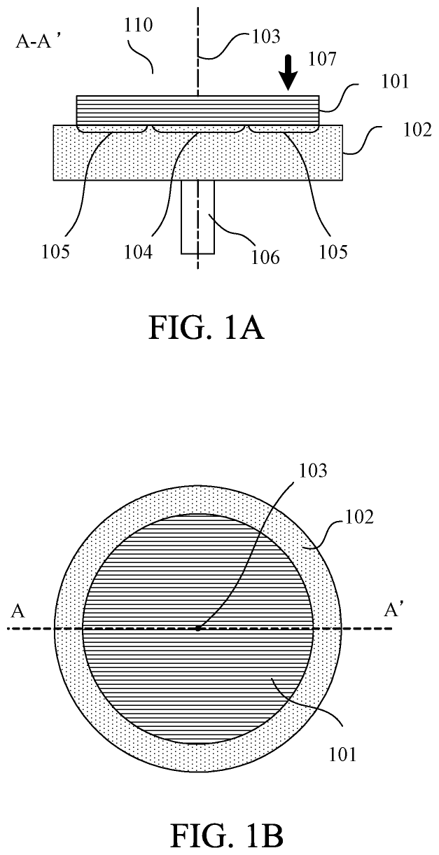

Referring now to FIGS. 1A and 1B, a description will be given of a first embodiment according to the present invention. FIGS. 1A and 1B are explanatory views of an optical unit (phosphor wheel 110) according to this embodiment. FIG. 1A is a sectional view of the phosphor wheel 110, and FIG. 1B is a plan view (viewed from the top) of the phosphor wheel 110, respectively. FIG. 1A corresponds to a section taken along a line A-A′ in FIG. 1B.

The phosphor wheel 110 includes a fluorescent layer 101 and a reflection plate 102 (substrate). The phosphor wheel 110 wavelength-converts excitation light from a solid light source (excitation light source), such as a laser diode, outputs fluorescent light, and is used as a light source for a projector (projection type display apparatus) etc. The fluorescent layer 101 includes a phosphor or a phosphor containing body (a mixture containing a phosphor and a binder), but is not limited to this embodiment, and may have another configuration as long as it is a layer containing at least a phosphor or fluorescent material.

At least part of one surface (lower surface) of the fluorescent layer 101 is adhered and fixed to one surface (upper surface) of the reflection plate 102. This is because when light enters the fluorescent layer 101, the fluorescent layer 101 generates the heat and becomes a high temperature, and the light intensity emitted from the fluorescent layer 101 may decrease. In other words, it is necessary to radiate the heat from the fluorescent layer 101 to the reflection plate 102 by adhering at least part of one surface of the fluorescent layer 101 to the reflection plate 102.

A shaft 106 is attached to the reflection plate 102 on the side opposite to the adhesion surface with the fluorescent layer 101. The shaft 106 can rotate the fluorescent layer 101 and the reflection plate 102 by rotating around a rotation axis 103 (predetermined axis). This configuration can suppress a temperature rise of the fluorescent layer 101 by rotating the fluorescent layer 101 and the reflection plate 102. When it is unnecessary to rotate the fluorescent layer 101, the shaft 106 may not be provided.

This embodiment provides an adhered portion 104 and a non-adhered portion 105 between the fluorescent layer 101 and the reflection plate 102. The fluorescent layer 101 and the reflection plate 102 are adhered to each other at the adhered portion 104, but are not adhered to each other at the non-adhered portion 105. In other words, the fluorescent layer 101 is not adhered to the reflection plate 102 over one entire surface (lower surface), but is adhered to the reflection plate 102 (only at the adhered portion 104) on part of the one surface (part of the lower surface). This embodiment provides the adhered portion 104 of the fluorescent layer 101 in a region including the rotation axis 103 (the center of the reflection plate 102), but the present invention is not limited to this embodiment.

In this embodiment, the term “adhesion” refers to the adhered state by an adhesive agent (adhesion state), the stuck state by a sticking agent (sticky state), or the direct bonded state between atoms (interatomic bond state), etc., but the present invention is not limited to this embodiment. For example, the fluorescent layer 101 is held (in an adsorption state) by the adsorption (adsorption portion) by penetrating an absorption hole near the center of the reflection plate 102 and by reducing the air pressure on the back surface of the reflection plate 102. The fluorescent layer and the reflection plate are not adhered to each other outside the adsorption portion.

The fluorescent layer 101 and the reflection plate 102 are located close to each other at the non-adhered portion 105. In this embodiment, the close location means that at least parts of the fluorescent layer 101 and the reflection plate 102 contact each other or they are disposed close to each other although they do not contact each other.

In this embodiment, as shown by an arrow in FIG. 1A, light 107 (excitation light) is introduced only to the non-adhered portion 105 of the phosphor wheel 110 (is not introduced to the adhered portion 104). Part of the light 107 incident on the phosphor wheel 110 is wavelength-converted by the fluorescent layer 101 and emitted to the upper side in FIG. 1A. The reflection plate 102 can increase the light emitted from the phosphor wheel 110. In this embodiment, the light 107 may be introduced to both the non-adhered portion 105 and the adhered portion 104, or only to the adhered portion 104.

Due to the light 107 incident on the fluorescent layer 101, the fluorescent layer 101 generates the heat. This embodiment radiates the heat from the fluorescent layer 101 to the reflection plate 102 mainly via the adhered portion 104. If the fluorescent layer 101 and the reflection plate 102 physically contact each other, the heat is radiated also via the non-adhered portion 105. This heat radiation can retrain the temperature of the fluorescent layer 101 from rising, and consequently restrain the emission intensity of the fluorescent layer 101 from deteriorating.

Next follows a reason why this embodiment can restrain the fluorescent layer 101 from deteriorating. In the adhered portion 104, a compressive or tensile force can be exerted on the fluorescent layer 101 from the reflection plate 102. An increase or decrease in temperature may increase or decrease this force. When the fluorescent layer 101 and the reflection plate 102 change their temperatures and the fluorescent layer 101 and the reflection plate 102 have the coefficients of thermal expansion different from each other, the force can change in the adhered portion 104 even if the temperature variation amount is equal between the fluorescent layer 101 and the reflection plate 102. When the fluorescent layer 101 and the reflection plate 102 change their temperatures and the temperature change amount is different between them, the force can change in the adhered portion 104 even if the thermal expansion coefficient is equal between the fluorescent layer 101 and the reflection plate 102. As described above, the magnitude of the force can change in the adhered portion 104 as the temperature increases or decreases (with the temperature fluctuation).

On the other hand, the force that can be exerted on the fluorescent layer 101 from the reflection plate 102 is weaker in the non-adhered portion 105 than that in the adhered state (adhered portion 104). In addition, due to the temperature increase or decrease, the fluorescent layer 101 and the reflection plate 102 can move separately from each other. Thus, the change in the force exerted from the reflection plate 102 to the fluorescent layer 101 in the non-adhered portion 105 is smaller than that in the adhered state. Hence, the deterioration of the fluorescent layer 101 can be suppressed where the non-adhered portion 105 provided as in this embodiment more effectively than a case where one entire surface (lower surface) of the fluorescent layer 101 is adhered (when the one entire surface of the fluorescent layer 101 is set to the adhered portion).

Next follows a description of a reason for providing the adhered portion 104 in this embodiment. Even if the adhered portion 104 is not provided between the fluorescent layer 101 and the reflection plate 102 in FIGS. 1A and 1B, the fluorescent layer 101 and the reflection plate 102 may be rotated by the frictional force between the fluorescent layer 101 and the reflection plate 102 without shifting their positions or phases. However, if the adhered portion 104 is not provided between the fluorescent layer 101 and the reflection plate 102, the positions and the phases of the fluorescent layer 101 and the reflection plate 102 are likely to shift from each other when the reflection plate 102 rotates fast. In addition, if no adhered portion 104 is provided between the fluorescent layer 101 and the reflection plate 102, the fluorescent layer 101 is not held in contact with the reflection plate 102 and may fall depending on the relationship between the direction of the rotation axis 103 and the direction of the weight. Thus, the adhered portion 104 is necessary in order to restrain the position and phase from shifting between the fluorescent layer 101 and the reflection plate 102.

If the fluorescent layer is pressed downwardly from above by a leaf spring instead of providing the adhered portion with the reflection plate to the fluorescent layer, the force of the leaf spring may increase the frictional force between the fluorescent layer and the reflection plate. However, as in this embodiment described with reference to FIGS. 1A and 1B, the phosphor wheel 110 becomes larger as compared with a configuration in which the fluorescent layer and the reflection plate are adhered by the adhesive or the like. For example, the adhesive having a thickness of about several micrometers can adhere the fluorescent layer and the reflection plate, but the friction force obtained by the leaf spring of the same thickness is relatively small and has difficulties in reliably adhering the fluorescent layer and the reflection plate. The configuration according to this embodiment provided with the adhered portion using the adhesive or the like can easily suppress the positional shift between the fluorescent layer and the reflection plate while keeping the phosphor wheel compact.

Next follows a description of a variation of this embodiment. When the adhered portion of the fluorescent layer is provided only near the rotation axis of the reflection plate and the temperature rises, the reflection plate thermally expands from the rotation axis to the outside and the fluorescent layer thermally expands from the adhered portion to the outside. In this case, the force applied to the fluorescent layer from the reflection plate is larger on the inner side (rotational shaft side) of the adhered portion than that on the outer side of the adhered portion, so the region of the adhered portion may be made as narrow as possible near the rotation axis. If the area of the adhered portion is narrow, however, the adhesion between the fluorescent layer and the reflection plate may be insufficient. Then, as the phosphor wheel rotates, a torque is generated and the fluorescent layer may be peeled off. From this point of view, the region of the adhered portion may be wider. Nevertheless, this embodiment does not limit the size of the region of the adhered portion. While the adhered portion may be located near the rotation axis, this embodiment is not limited to this embodiment.

The adhered portion on the plane perpendicular to the rotation axis may have an arbitrary planar shape, such as a circle, a polygon, a figure surrounded by a straight line or a curve, or a plurality of these figures. While the reflection plate is wider than the fluorescent layer in FIG. 1B, the fluorescent layer may be wider than the reflection plate or the fluorescent layer and the reflector may have the same size.

The fluorescent layer and the reflection plate may not be in close contact with each other at the non-adhered portion due to warping of the fluorescent layer or the reflection plate, but the adhesion properly can be improved by holding the fluorescent layer and the reflection plate by an elastic body, such as a leaf spring and a clip, from the outer circumference. The pressure of the leaf spring or the clip can be properly adjusted to suppress the deterioration of the fluorescent layer due to this pressure.

The fluorescent layer 101 can employ a monocrystal of phosphor, a polycrystal of phosphor, a mixture in which phosphor powder is dispersed in resin or glass (phosphor containing body), or the like. The fluorescent layer 101 can be made, for example, of Ce doped YAG (Y₃Al₅O₁₂: Ce), but the present invention is not limited to this material and can use any other materials as long as they contain a phosphor for converting the wavelength of light. The reflection plate 102 can use metal such as aluminum. In addition, the surface of the reflection plate 102 may be coated with a material having a high reflectance. This embodiment does not limit the material and the reflectance of the reflection plate 102. The adhesive can use an epoxy-based adhesive, a silicon-based adhesive, or the like, but is not limited to these examples. The shaft 106 may be made of metal such as aluminum, but is not limited to this example.

The fluorescent layer 101 made of YAG has a coefficient of thermal expansion of about 7×10⁻⁶/° C. The reflection plate 102 made of aluminum has a coefficient of thermal expansion of about 23×10⁻⁶/° C. If the temperature rises, the volume of aluminum as the reflection plate 102 changes more than the volume of YAG as the fluorescent layer 101. However, these coefficients of thermal expansion are merely illustrative, and this embodiment is not limited to this example.

This embodiment can provide a phosphor wheel (optical unit) capable of suppressing the deterioration of the fluorescent layer.

### Second Embodiment

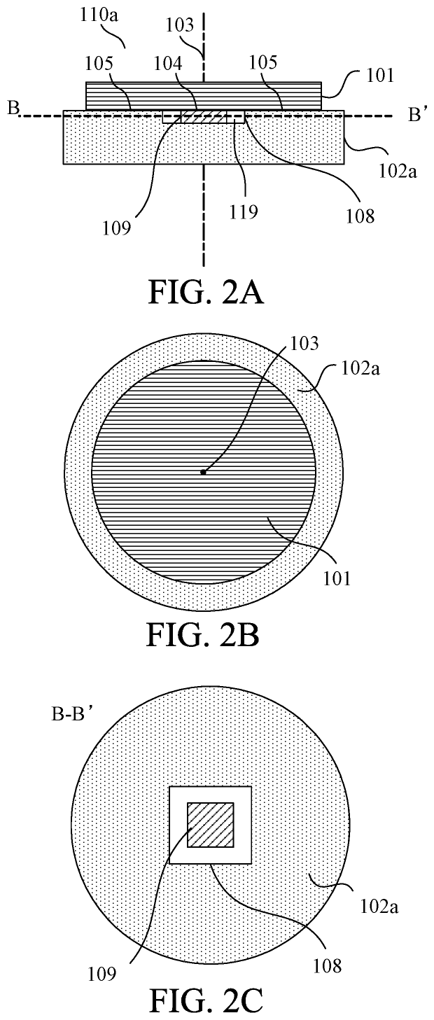

Referring now to FIGS. 2A, 2B, and 2C, a description will be given of a second embodiment according to the present invention. FIGS. 2A, 2B, and 2C are explanatory views of an optical unit (phosphor wheel 110a) according to this embodiment. FIG. 2A is a sectional view of the phosphor wheel 110a, FIG. 2B is a top view, and FIG. 2C is a plan view taken along a line B-B′ in FIG. 2A.

The phosphor wheel 110a according to this embodiment has a groove (concave portion) 108 in the reflection plate 102a. An adhesive 109 is provided in the groove 108 and adheres the fluorescent layer 101 and the reflection plate 102a to each other. If the reflection plate 102a has no groove 108, a gap may be generated between the fluorescent layer 101 and the reflection plate 102a at the non-adhered portion 105 due to the thickness of the adhesive 109. On the other hand, when the groove 108 is formed as in the reflection plate 102a according to this embodiment, the fluorescent layer 101 and the reflection plate 102a can be easily adhered to each other at the non-adhered portion 105. By bringing the fluorescent layer 101 and the reflection plate 102a into close contact with each other, the heat can be more efficiently radiated from the fluorescent layer 101 to the reflection plate 102a.

This embodiment provides an air gap 119 in the groove 108. By introducing the adhesive 109 so that the air gap 119 remains in the groove 108, the adhesive 109 is unlikely to project out, and the fluorescent layer 101 and the reflection plate 102a are likely to be adhere to each other at the non-sticking portion 105. This embodiment does not limit the shapes of the groove 108, the adhesive 109, and the air gap 119, and may have any shapes. For example, as illustrated in the sectional view in FIG. 2A and the plan view of FIG. 2C, the groove 108 and the adhesive 109 are both shown as rectangular, but this embodiment is limited to this example. The shape may be surrounded by a straight line or curve in the sectional view of FIG. 2A, or the shape may be surrounded by a straight line or curve in the plan view of FIG. 2C. As illustrated in FIGS. 2A to 2C, as the adhesive 109 is narrower than the groove 108 and the adhesive 109 is located only in a partial region including the rotation axis 103 in the groove 108, the adhered portion 104 is narrower and the non-adhered portion 105 is wider than those where the entire width of the groove 108 is adhered.

In this embodiment, the adhered portion 104 is part of the fluorescent layer 101 corresponding to the region where the adhesive 109 is provided. In this embodiment, the groove 108 is wider than the adhesive 109 in the direction parallel to the contact surface with the fluorescent layer 101.

Next follows a description of an illustrative method of manufacturing the phosphor wheel 110a. This embodiment provides the fluorescent layer 101 by cutting out YAG (Y₃Al₅O₁₂) grown as a monocrystal into a disc shape. The disc plane can be made a cleavage plane of the crystal. The reflection plate 102a uses aluminum processed into a disc shape having the groove 108.

An epoxy-based adhesive 109 is applied to the central portion of the groove 108 in the reflection plate 102a (part inside the groove 108 including the rotation shaft 103). At this time, the volume of the adhesive 109 is made smaller than that of the groove 108, and the height of the adhesive 109 is made longer than the depth of the groove 108 at the center of the groove 108. Next, the disc-shaped fluorescent layer 101 is pressed from above to make the fluorescent layer 101 and the reflection plate 102a be in close contact with each other outside the groove 108 of the reflection plate 102a. At this time, the adhesive 109 is uncured and deformed by pressing the fluorescent layer 101. This configuration can make a portion where the height of the adhesive 109 is approximately the same as the depth of the groove 108.

Next, the fluorescent layer 101, the reflection plate 102a, and the adhesive 109 are heated to cure the adhesive. By heating and curing the adhesive 109, part of one surface (lower surface) of the fluorescent layer 101 and the reflection plate 102a are adhered to each other. Instead of the method of heating and curing the adhesive 109, this embodiment may use an (ultraviolet curing) method of irradiating and curing the adhesive 109 with ultraviolet light.

### Third Embodiment

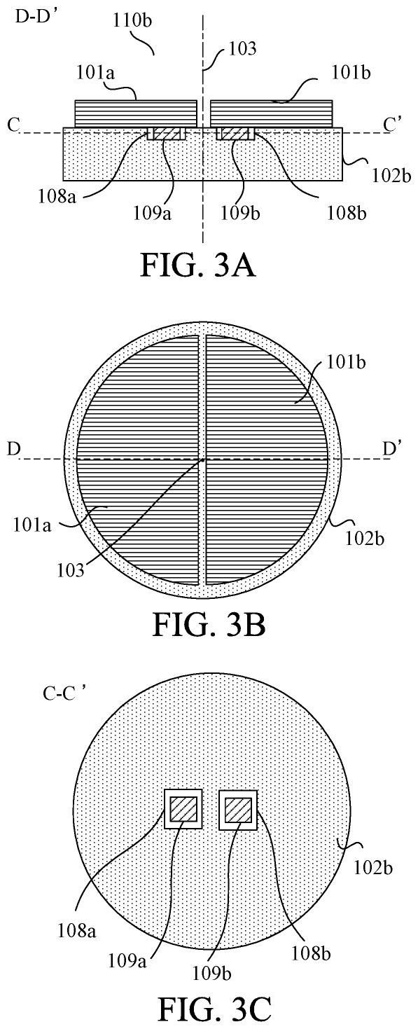

Referring now to FIGS. 3A, 3B, and 3C, a description will be given of a third embodiment according to the present invention. FIGS. 3A, 3B, and 3C are explanatory views of an optical unit (phosphor wheel 110b) according to this embodiment. FIG. 3A is a sectional view of a phosphor wheel 110b, FIG. 3B is a top view, and FIG. 3C is a plan view taken along a line C-C′ in FIG. 3C.

As illustrated in FIGS. 3A to 3C, in the phosphor wheel 110b according to this embodiment, the fluorescent layer 101 has a plurality of fluorescent layers (first fluorescent layer 101a and second fluorescent layer 101b) separated from each other. The adhered portion 104 has a first adhered portion corresponding to the region of an adhesive 109a and a second adhered portion corresponding to the region of an adhesive 109b. In this embodiment, a groove (first concave portion) 108a and the groove (second concave portion) 108b are formed in the reflection plate 102b, and the adhesive (first adhesive) 109a is formed in the first concave portion. An adhesive (second adhesive) 109b is provided in the second concave portion. The first fluorescent layer 101a is adhered to the reflection plate 102b in the first adhered portion (adhesive 109a). The second fluorescent layer 101b is adhered to the reflection plate 102b in the second adhered portion (adhesive 109b). In this embodiment, the first adhered portion is part in the first fluorescent layer corresponding to the region where the first adhesive is provided, and the second adhered portion is part in second fluorescent layer corresponding to the region where the second adhesive is provided.

As described above, in this embodiment, the fluorescent layers 101 (the first fluorescent layer 101a and the second fluorescent layer 101b) separated into a plurality of layers is adhered to the single reflection plate 102b. Each fluorescent layer is adhered to the reflection plate 102b at part (adhered portion 104) of one surface of each fluorescent layer. Part other than the adhered portion 104 in the same surface of each fluorescent layer has a region (non-adhered portion 105) in contact with (or located close to) the reflection plate 102b while it is not adhered to the reflection plate 102b. This embodiment can suppress the deterioration of the fluorescent layer more effectively than a structure in which the one entire surface of each phosphor is adhered to the reflection plate.

As illustrated in FIGS. 3A and 3B, this embodiment separates the first fluorescent layer 101a and the second fluorescent layer 101b from each other, but the present invention is limited to this embodiment. The two fluorescent layers may be in contact with each other or located close to each other. This embodiment separates the fluorescent layer into two fluorescent layers, but the present invention is not limited to this embodiment and the fluorescent layer may be separated into three or more fluorescent layers. In this embodiment, the plurality of fluorescent layers have the same shape (semicircular shape as illustrated in FIG. 3B), but the present invention is not limited to this embodiment and may have different shapes. The combined shape of the plurality of phosphors does not have to be circular, and may be another shape such as an annular shape.

### Fourth Embodiment

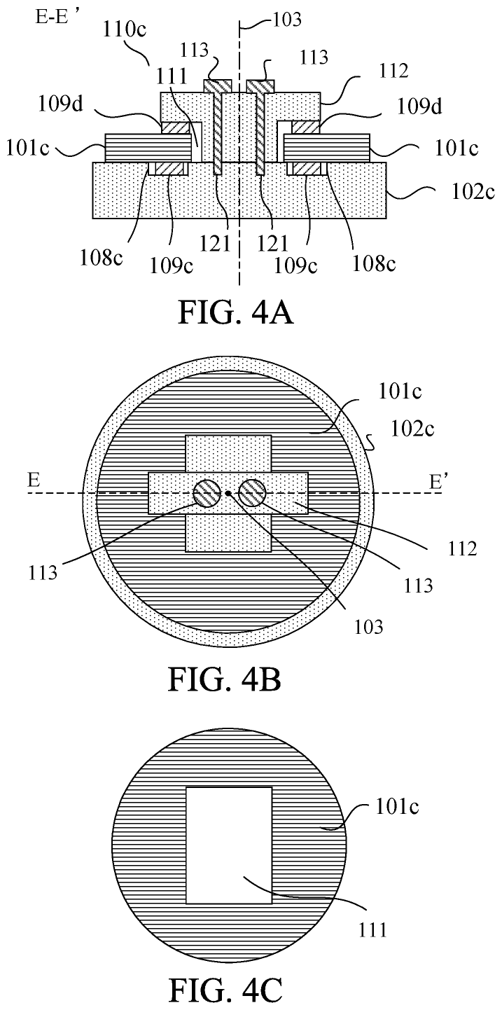

Referring now to FIGS. 4A, 4B, and 4C, a description will be given of a fourth embodiment according to the present invention. FIGS. 4A, 4B, and 4C are explanatory views of an optical unit (phosphor wheel 110c) according to this embodiment. FIG. 4A is a sectional view of the phosphor wheel 110c, FIG. 4B is a top view, and FIG. 4C is a plan view taken along a line E-E′ in FIG. 4A. FIG. 4A corresponds to a section taken along the line E-E′ in FIG. 4B.

As illustrated in FIG. 4A, a fluorescent layer 101c and a reflection plate 102c adhered to each other by a first adhesive 109c. A holding member 112 is disposed on the reflection plate 102c. The reflection plate 102c and the holding member 112 are fixed by a screw 113 (fixing member). A hole 121 for fixing the screw 113 is formed in the reflection plate 102c. The holding member 112 and the fluorescent layer 101c are adhered to each other by a second adhesive 109d. In other words, at least part of the surface of the fluorescent layer 101c opposite to the one surface having the adhered portion 104 is adhered to the holding member 112 integrated with the reflection plate 102c. This embodiment forms a penetration hole 111 in the fluorescent layer 101c. The holding member 112 and the screw 113 can be disposed by providing the penetration hole 111.

The embodiment fixes the fluorescent layer 101c onto the reflection plate 102c by the holding member 112, the screw 113, and the second adhesive 109d. This configuration can further suppress a positional shift of the fluorescent layer 101c more effectively than a configuration in which the fluorescent layer 101c is adhered to the reflection plate 102c only with the first adhesive 109c.

Next follows a description of an illustrative method of manufacturing the phosphor wheel 110c. Initially, the hole 121 for fixing the screw 113 is formed in the reflection plate 102c. The penetration hole 111 is formed in the fluorescent layer 101c. Similar to the manufacturing method described in the second embodiment, the fluorescent layer 101c and the reflection plate 102c are adhered by the first adhesive 109c. Next, the second adhesive 109d is applied to the fluorescent layer 101c. The uncured second adhesive 109d is made thicker than the second adhesive 109d illustrated in FIG. 4A. The second adhesive 109d is pressed by the holding member 112 and deformed by pressing the holding member 112 against the reflection plate 102c. Then, the pressure is applied from the screw 113 to the holding member 112 and transmitted from the holding member 112 to the reflection plate 102c by tightening the screw 113. A deformation of the second adhesive 109d is approximately settled a predetermined time after the screw 113 is fixed, and the pressure applied from the second adhesive 109d to the fluorescent layer 101c is reduced. Thus, the second adhesive 109d is cured (thermally or through ultraviolet) to adhere the fluorescent layer 101c and the holding member 112 to each other.

Next follows a description of a variation of this embodiment. While FIGS. 4A, 4B, and 4C illustrate an example in which a single penetration hole 111 is formed in a single fluorescent layer 101c, a plurality of penetration holes may be formed in the single fluorescent layer 101c. The holding member 112, the screw 113, and the second adhesive 109d can be disposed for each penetration hole. By increasing the number of adhesion spots of the second adhesive 109d, the positional shift of the fluorescent layer 101c can be further suppressed. The plurality of penetration holes, the plurality of holding members, and the plurality of second adhesives do not have to have the same shape. Each of the penetration hole, the holding member, and the second adhesive may have any shape. Further, a plurality of holding members 112, screws 113, and second adhesive 109d may be provided to the single penetration hole. Even in this case, each of the penetration hole, the holding member, and the second adhesive can have any shape.

### Fifth Embodiment

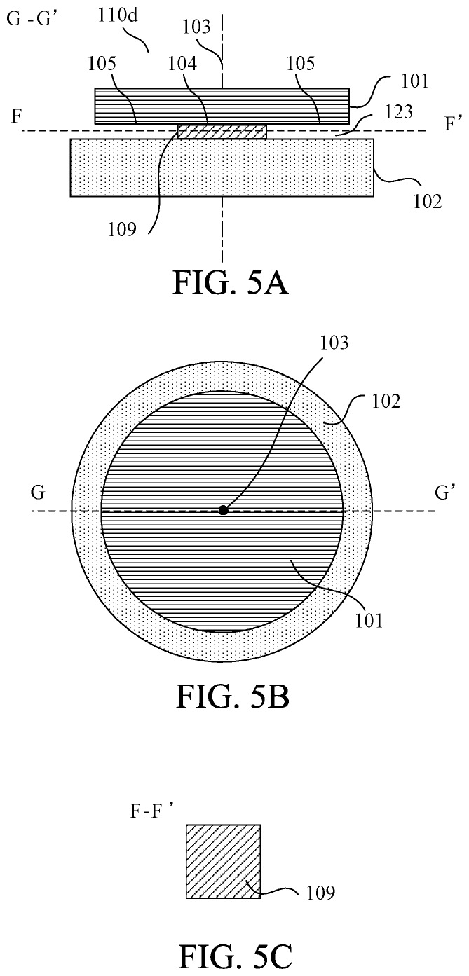

Referring now to FIGS. 5A, 5B, and 5C, a description will be given of a fifth embodiment according to the present invention. FIGS. 5A, 5B, and 5C are explanatory views of an optical unit (phosphor wheel 110d) according to this embodiment. FIG. 5A is a sectional view of the phosphor wheel 110d, FIG. 5B is a top view, and FIG. 5C is a plan view taken along a line F-F′ in FIG. 5A. FIG. 5A corresponds to a section taken along a line G-G′ in FIG. 5B.

As illustrated in FIG. 5A, part of one surface (lower surface) of the fluorescent layer 101 is adhered to the reflection plate 102 by the adhesive 109. In FIGS. 5A, 5B, and 5C, the non-adhered portion 105 of the fluorescent layer 101 and the reflection plate 102 are located close to each other while they do not contact each other (while they are spaced by an air gap 123 between the fluorescent layer 101 and the reflection plate 102). When light is introduced from the upper side in FIG. 5A only to the region in the fluorescent layer 101 corresponding to the non-adhered portion 105, part of the incident light passes through the air gap 123, is reflected by the reflection plate 102, passes through the layer 101, and is emitted to the upper side of the fluorescent layer 101.

### Sixth Embodiment

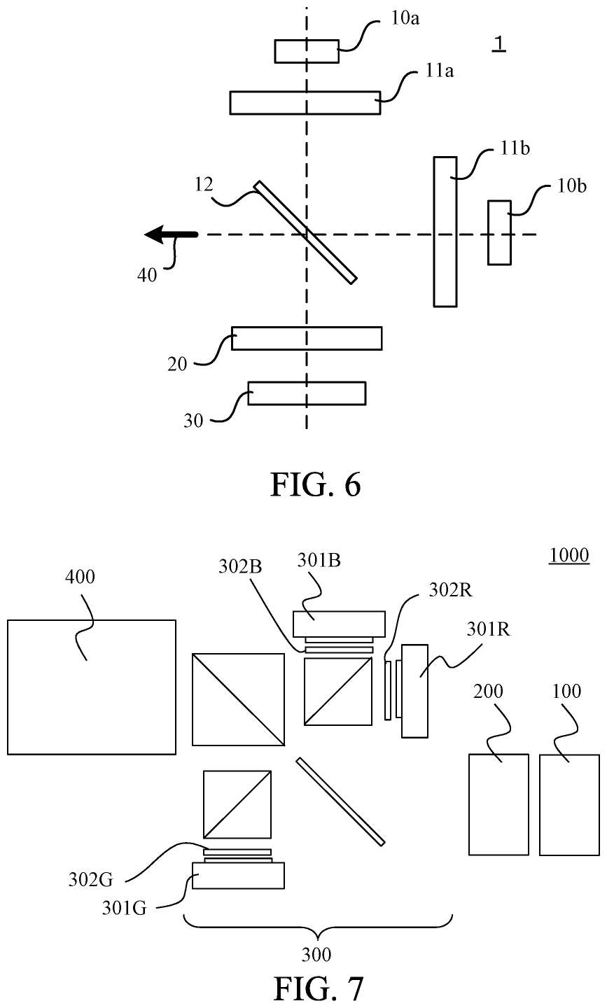

Referring now to FIG. 6, a description will be given of a sixth embodiment according to the present invention. FIG. 6 is a structural view of a light source apparatus 1 according to this embodiment. In FIG. 6, reference numerals 10a and 10b denote laser light sources (solid light sources), reference numerals 11a and 11b denote condenser lens systems, reference numeral 12 denotes a dichroic mirror, reference numeral 20 denotes a condenser lens system, and reference numeral 30 denotes a phosphor wheel (optical unit). The phosphor wheel 30 includes a fluorescent layer, and corresponds to, for example, one of the phosphor wheels 110 to 110d according to the embodiments described above.

The laser light source 10a emits blue light (B light). The B light passes through the condenser lens system 11a and is guided to the dichroic mirror 12. The dichroic mirror 12 transmits the B light. Therefore, the light flux from the laser light source 10a passes through the dichroic mirror 12 and the condenser lens system 20 and is guided to the phosphor wheel 30. Part of the B light incident on the phosphor wheel 30 is converted into yellow light (Y light) by the fluorescent layer. The Y light contains red light (R light) and green light (G light). The Y light passes through the condenser lens system 20 and is guided to the dichroic mirror 12. The Y light is reflected by the dichroic mirror 12 and guided in a direction of an arrow 40 in FIG. 6.

The laser light source 10b emits the blue light (B light). The B light passes through the dichroic mirror 12 and is guided in the direction of the arrow 40. The light guided in the direction of the arrow 40 contains the Y light and B light, and the Y light contains the R light and the G light. Thus, the light source apparatus 1 can emit light including the R light, the G light, and B light. The light source apparatus 1 illustrated in FIG. 6 is merely illustrative, and this embodiment is also applicable to the light source apparatus of another structure. Instead of the laser light source, a solid light source such as an LED can also be used. This embodiment can arbitrarily set the number of light sources and the arrangement of optical members such as a lens and a mirror.

### Seventh Embodiment

Referring now to FIG. 7, a description will be given of a seventh embodiment according to the present invention. FIG. 7 is a structural view of a projector 1000 (projection type display apparatus) according to this embodiment. A light modulation element of the projector 1000 uses a reflection type liquid crystal panel. In FIG. 7, reference numeral 100 denotes a light source (corresponding to the light source apparatus 1), reference numeral 200 denotes an illumination optical system, reference numeral 300 denotes a color separation and combination optical system, and reference numeral 400 denotes a projection optical system. The light source 100 emits light toward the illumination optical system 200. The illumination optical system 200 illuminates a light modulation element described later using the light from the light source 100. The color separation and combination optical system 300 performs a color separation and color combination for the illumination light from the illumination optical system 200. The projection optical system 400 projects the combined light from the color separation and combination optical system 300.

In the color separation and combination optical system 300, reference numerals 301R, 301G, and 301B respectively denote reflection type liquid crystal panel units including red, green, and blue light modulation elements (reflection type liquid crystal panels for red, green, and blue). Reference numerals 302R, 302G, and 302B denote waveplate units provided with red, green, and blue waveplates, respectively. In this embodiment, the light modulation elements included in each of the reflection type liquid crystal panel units 301R, 301G, and 301B are reflection type liquid crystal panels, but the present invention is not limited to this embodiment. For example, a transmission type liquid crystal panel may be used as the light modulation element. Regardless of the number of reflective liquid crystal panels, the present invention is applicable to any single-plate type or three-plate type projector.

Each embodiment can provide an optical unit, a light source apparatus, and a projector, each of which can suppress the deterioration of the fluorescent layer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

For example, each embodiment provides a fluorescent layer onto a reflection plate (substrate) that reflects light, but the present invention is not limited to this embodiment. For example, the fluorescent layer may be provided onto a transmission plate (substrate) that transmits light. In each embodiment, the non-adhered portion of the fluorescent layer contacts or is located close to the reflection plate, but the present invention is not limited to this embodiment and the non-adhered portion may be separated from the reflection plate.

What is claimed is:

1. An optical unit comprising:
a substrate; and
a fluorescent layer provided on the substrate,
wherein the fluorescent layer includes an adhered portion adhered to the substrate and a non-adhered portion that is not adhered to the substrate,
wherein the substrate has a concave portion containing an air gap and an adhesive,
wherein the adhered portion is part in the fluorescent layer corresponding to a region where the adhesive is provided, and
wherein an end of the fluorescent layer is located outside the concave portion.

2. The optical unit according to claim 1, wherein the adhered portion is provided only on part of one surface of the fluorescent layer.

3. The optical unit according to claim 1, wherein the substrate is a reflection plate configured to reflect light incident through the fluorescent layer.

4. The optical unit according to claim 1, wherein the substrate is a transmission plate configured to transmit light incident through the fluorescent layer.

5. The optical unit according to claim 1, wherein the substrate and the fluorescent layer rotate around a predetermined axis.

6. The optical unit according to claim 5, wherein the adhered portion of the fluorescent layer is provided in a region including the predetermined axis.

7. The optical unit according to claim 1, wherein at least part of the non-adhered portion of the fluorescent layer contacts the substrate.

8. The optical unit according to claim 1, wherein the non-adhered portion of the fluorescent layer does not contact the substrate.

9. The optical unit according to claim 1, wherein the fluorescent layer includes a first fluorescent layer and a second fluorescent layer,
wherein the adhered portion includes a first adhered portion of the first fluorescent layer and a second adhered portion of the second fluorescent layer,
wherein the concave portion has a first concave portion and a second concave portion,
wherein the adhesive includes a first adhesive provided in the first concave portion and a second adhesive provided in the second concave portion,
wherein the first fluorescent layer is adhered to the substrate at the first adhered portion,
wherein the second fluorescent layer is adhered to the substrate at the second adhered portion,
wherein the first adhered portion is part in the first fluorescent layer corresponding to a region where the first adhesive is provided, and
wherein the second adhered portion is part in the second fluorescent layer corresponding to a region where the second adhesive is provided.

10. The optical unit according to claim 1, wherein the fluorescent layer has a penetration hole.

11. The optical unit according to claim 1, wherein at least part of a surface opposite to one surface having the adhered portion is adhered to a holding member integrated with the substrate.

12. The optical unit according to claim 1, wherein the concave portion is wider than the adhesive in a direction parallel to a contact surface with the fluorescent layer.

13. The optical unit according to claim 1, wherein excitation light from an excitation light source enters a region corresponding to the non-adhered portion of the fluorescent layer.

14. The optical unit according to claim 1, wherein a whole of the fluorescent layer is provided on an opposite side of the concave portion with respect to a surface different from a surface of part of a surface of the substrate where the concave portion is provided.

15. A light source apparatus comprising:
an excitation light source; and
an optical unit,
wherein an optical unit includes:
a substrate; and
a fluorescent layer provided on the substrate,
wherein the fluorescent layer includes an adhered portion adhered to the substrate and a non-adhered portion that is not adhered to the substrate,
wherein the substrate has a concave portion containing an air gap and an adhesive,
wherein the adhered portion is part in the fluorescent layer corresponding to a region where the adhesive is provided, and
wherein an end of the fluorescent layer is located outside the concave portion.

16. The light source apparatus according to claim 15, wherein the excitation light source is disposed such that excitation light from the excitation light source enters a region corresponding to the non-adhered portion of the fluorescent layer.

17. A projection type display apparatus comprising:
a light source apparatus;
a light modulation element;
an illumination optical system configured to illuminate the light modulation element using light from the light source apparatus; and
a color separation and combination optical system configured to perform a color separation and color combination for illumination light from the illumination optical system,
wherein an optical unit includes:
a substrate; and
a fluorescent layer provided on the substrate,
wherein the fluorescent layer includes an adhered portion adhered to the substrate and a non-adhered portion that is not adhered to the substrate,
wherein the substrate has a concave portion containing an air gap and an adhesive,
wherein the adhered portion is part in the fluorescent layer corresponding to a region where the adhesive is provided, and
wherein an end of the fluorescent layer is located outside the concave portion.
